(19) United States
(12) Patent Application Publication
(10) Pub. No.: US 2016/0232467 A1
(43) Pub. Date: Aug. 11, 2016

(54) SYSTEM AND METHOD FOR OPTIMIZING THE RISK DURING SOFTWARE PRODUCTION RELEASE

(71) Applicants: Deepa Natarajan, Chennai (IN); Sumithra Sundaresan, Chennai (IN)

(72) Inventors: Deepa Natarajan, Chennai (IN); Sumithra Sundaresan, Chennai (IN)

(73) Assignee: Wipro Limited, Bangalore Karnataka (IN)

(21) Appl. No.: 14/668,304

(22) Filed: Mar. 25, 2015

(30) Foreign Application Priority Data
Feb. 10, 2015 (IN) 655/CHE/2015

(51) Int. Cl. G06Q 10/06

(52) U.S. Cl. CPC G06Q 10/0635

(57) ABSTRACT

A system and method for optimizing risk during software production release are disclosed. The method may involve receiving, one or more project requirements associated with the software project and one or more project defects associated with the software project; identifying, one or more critical project requirements and one or more critical project defects from the one or more project requirements and the one or more project defects; ascertaining, a requirement density for the software project based on the one or more critical project requirements and the one or more project requirements; ascertaining, a defect density based on the one or more critical project defects and the one or more project defects; and determining a cumulative risk score for the software project using the requirement density and the defect density.

### PRIORITY CLAIM

This U.S. patent application claims priority under 35 U.S.C. §119 to: India Application No. 655/CHE/2015, filed Feb. 10, 2015. The entire content of the aforementioned application is incorporated herein by reference.

### TECHNICAL FIELD

This disclosure relates generally to a software production release, and more particularly to a system and method for optimizing risk during software production release.

### BACKGROUND

Typically, business requirements are critical activities of an enterprise that must be performed to meet organizational objectives. Such business requirements may be achieved by introducing a software solution. Typically, the software solution may include one or more software projects. Each software project may be developed by a different team and then the various projects may be brought together as a solution to meet the business requirements. The success of a software project may be measured by factors such as timely completion and actual implementation of the business requirements. However, during a software production release, effective prioritization of business requirements for optimizing risk may not be performed. Hence, the business requirements may enter into production without any impact analysis, and risk mitigation being performed. This may lead to high priority defects uncovered in the production.

At present, the risk analysis and prioritization is done manually by a business user, which is person dependent and error-prone. There is no systematic way for risk identification and prioritization of project requirements in the release. Slippage of highly critical defects to production cycles may cause a rollback of the release thereby leading to lack of confidence within different business stakeholders.

### SUMMARY

In one embodiment, a risk determination engine to determine risk associated with the software project is disclosed. The risk determination engine may comprise a memory and a processor coupled to the memory storing processor executable instructions to receive one or more project requirements associated with the software project and one or more project defects associated with the software project; identify one or more critical project requirements and one or more critical project defects from the one or more project requirements and the one or more project defects; ascertain a requirement density for the software project based on the one or more critical project requirements and the one or more project requirements; ascertain a defect density based on the one or more critical project defects and the one or more project defects; and determine a cumulative risk score for the software project using the requirement density and the defect density.

In another embodiment, a method for determining risk associated with a software project is disclosed. The method may involve receiving by a risk determination engine, one or more project requirements associated with the software project and one or more project defects associated with the software project; identifying, by the risk determination engine, one or more critical project requirements and one or more critical project defects from the one or more project requirements and the one or more project defects; ascertaining, by the risk determination engine, a requirement density for the software project based on the one or more critical project requirements and the one or more project requirements; ascertaining, by the risk determination engine, a defect density based on the one or more critical project defects and the one or more project defects; and determining, by the risk determination engine, a cumulative risk score for the software project using the requirement density and the defect density.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary diagram for an environment with risk determination engine 102 for determining risk in a software production release in accordance with various embodiments of the present disclosure.

FIG. 2 illustrates memory 110 which may include a facts analyzer, a density analyzer, a risk analyzer and a risk optimizer.

FIG. 3 illustrates a method for determining risk associated with a software project in accordance with some embodiments of the present disclosure.

FIG. 4 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

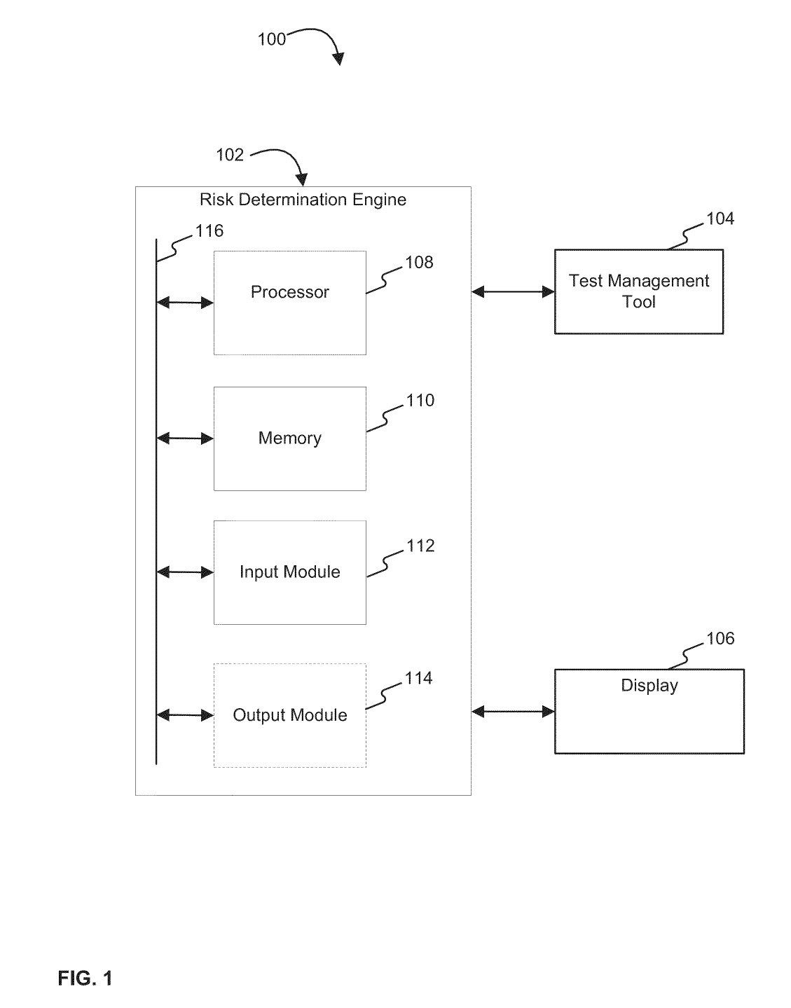

FIG. 1 illustrates an exemplary diagram for an environment 100 with risk determination engine 102 for determining risk in a software production release in accordance with various embodiments of the present disclosure. The software production release may comprise one or more software projects. The exemplary environment 100 may include risk determination engine 102, a test management tool 104, and a display 106. Risk determination engine 102 may further include a processor 108, a memory 110, an input module 112, and an output module 114. While not shown, the exemplary environment 100 may include additional components, such as database etc which are well known to those of ordinary skill in the art and thus will not be described here. The test management tool 104 may be used to store information on how testing is to be done, plan testing activities, report the status of quality assurance activities and defect information. The display 106 may be peripheral devices used to display result of risk determination engine 102 such as a monitor, a projector, a printer.

The risk determination engine 102 may assist in optimizing risk in the software production release and is described with examples herein, although risk determination engine 102 may perform other types and numbers of functions. The risk determination engine 102 may include at least one input device 112 CPU/processor 108, memory 110, and Output Module 114, which may be coupled together by bus 116, although risk determination engine 102 may comprise other types and numbers of elements in other configurations.

Processor(s) 108 may execute one or more computer-executable instructions stored in the memory 110 for the methods illustrated and described with reference to the examples herein, although the processor(s) can execute other types and numbers of instructions and perform other types and numbers of operations. The processor(s) 108 may comprise one or more central processing units (“CPUs”) or general purpose processors with one or more processing cores, such as AMD® processor(s), although other types of processor(s) could be used (e.g., Intel®).

The memory 110 may comprise one or more tangible storage media, such as RAM, ROM, flash memory, CD-ROM, floppy disk, hard disk drive(s), solid state memory, DVD, or other memory storage types or devices, including combinations thereof, which are known to those of ordinary skill in the art. The memory 110 may store one or more non-transitory computer-readable instructions of this technology as illustrated and described with reference to the examples herein that may be executed by the one or more processor(s) 108.

The input module 120 may receive one or more project requirements and one or more project defects from at least one of the test management module 112 or a user. The output module 160, may link the risk determination engine 102 with peripheral devices such as a display 106, to display the risk associated with the software project determined by the risk determination engine 102. The output module may trigger an email to share the risk associated with the software project with the stakeholders The output module may also be connected to a web based portal to display the risk associated with the software project.

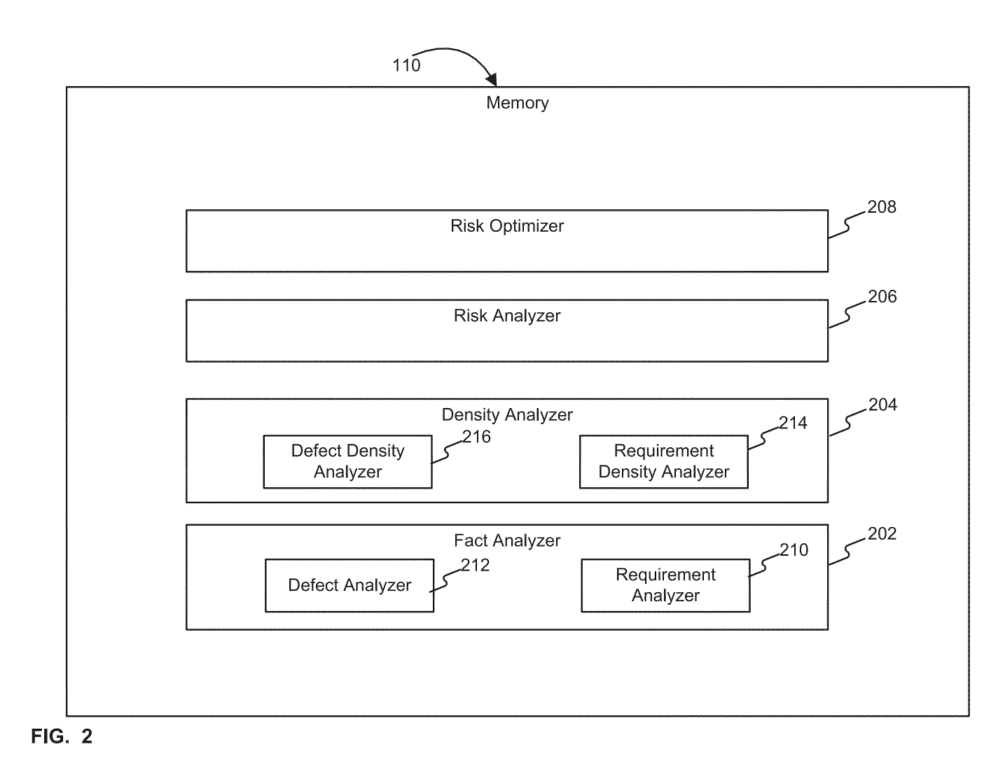

FIG. 2 illustrates memory 110 which may include a facts analyzer 202, a density analyzer 204, a risk analyzer 206 and a risk optimizer 208. The facts analyzer 202 may receive the one or more project requirements and the one or more project defects from the input module 120. The facts analyzer 202 may include a requirement analyzer 210 to analyze the one or more project requirements and a defect analyzer 212 to analyze the one or more project defects. The requirement analyzer 210 may analyze the one or more project requirements to identify one or more critical project requirements. Similarly, defect analyzer 212 may analyze the one or more project defects to identify one or more critical project requirements. The critical project requirements and the critical project defects may be identified based on a predefined weightage assigned to the one or more project requirements and the one or more project defects respectively.

Density analyzer 204 may ascertain a requirement density and a defect density based on the one or more critical project requirements and the one or more critical project defects received from fact analyzer 202. The density analyzer 204 may include a requirement density analyzer 214 and defect density analyzer 216. The requirement density analyzer 214 may ascertain the requirement density as a product of the one or more project requirements and the one or more critical project requirements divided by a summation of the one or more project requirements and the one or more critical project requirements. The defect density analyzer 216 may ascertain the defect density as a product of the one or more project defects and the one or more critical project defects divided by a summation of the one or more project defects and the one or more critical project defects.

Once the requirement density analyzer 214 and defect density analyzer 216 determine the requirement density and the defect density, risk analyzer 206 may then determine a cumulative risk score for the software project based on the requirement density and the defect density. The cumulative risk score may be determined as product of the requirement density and the defect density divided by a summation of the requirement density and the defect density.

The risk optimizer 208 identifies the risks involved in the software projects based on the data derived from risk analyzer 206. The risk determination engine 102 may determine one or more levels of risk associated with the software production release based on the cumulative risk score. The one or more levels of risk may be low, medium and high. A low risk level may be determined as average of minimum cumulative risk score and medium risk level. A medium risk level may be determined as average of maximum cumulative risk score and minimum cumulative risk score. A high risk level may be determined as average of maximum cumulative risk score and medium risk level.

Table A illustrates an exemplary embodiment for determining risk associated with a software release. In this example, the software release may include a project 1, a project 2, and a project 3. For project 1, the requirement density may be calculated using the equation:

$$Requirement density = \frac{( project requirements \times critical project requirements )}{( project requirements + critical project requirements )}$$

Thus the requirement density for project one may be calculated as:

Requirement density=(85×17)/(85+17)=14

Similarly, the defect density may be calculated as:

$$Defects density = \frac{( project defects \times critical project defects )}{( project defects + critical project defects )}$$

Thus the defect density for project one may be calculated as:

Requirement density=(76×56)/(76+56)=32

The Cumulative risk score may be calculated as:

$$Cumulative risk score = \frac{( requirement density \times defect density )}{( requirement density + defect density )}$$

Thus the cumulative risk score for project one may be calculated as:

Cumulative risk score=(14×32)/(14+32)=10.

TABLE A

| | | | Requirement | Defect | | | Risk |
|---|---|---|---|---|---|---|---|
| Input Module | | | Analyzer | Analyzer | Density Analyzer | | Analyzer |
| | Total | Total | No. of Critical | No of Critical | Requirement | Defect | Cumulative |
| Projects | Requirement | Defects | Requirement | defects | Density | Density | Risk Score |
| Project 1 | 85 | 76 | 17 | 56 | 14 | 32 | 10 |
| Project 2 | 13 | 38 | 2.6 | 24 | 2 | 15 | 2 |
| Project 3 | 38 | 1 | 7.6 | 0 | 6 | 0 | 0 |

The risk determination engine 102 based on the cumulative risk score may determine low, medium and high levels of risk associated with the software project. A low risk level may indicate successful release of the software project. A medium risk level may indicate a possibility of errors post release of the software project. A high risk level may indicate a possibility of failure post release of the software project. The software projects 1, 2 and 3 may be prioritized for optimizing risk based on the cumulative risk score. The software project 1 may be prioritized as high risk. The software project 2 may be assigned medium risk level and software project 3 may be assigned low risk level.

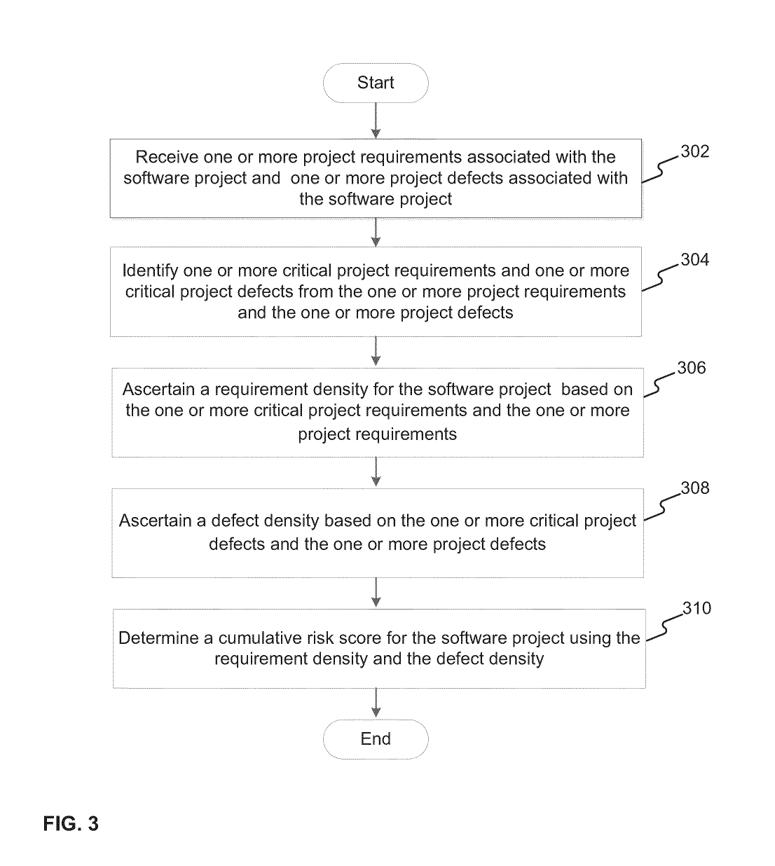

FIG. 3 illustrates an exemplary flow diagram of a method of determining risk associated with the software project, according to some embodiments of the present disclosure. The method may involve receiving, by the risk determination engine 102, the one or more project requirements associated with the software project and the one or more project defects associated with the software project at step 302. The one or more project requirements and the one or more project defects may be received by the input module 104 from at least one of the test management tool 104.

On receiving the one or more project requirements associated with the software project and one or more project defects with the software project at step 302 from the Input module 104, one or more critical projects and one or more critical defects may be identified by the fact analyzer 202 at step 304. The one or more critical project requirements may be identified by requirement analyzer 210 based on a predefined weightage assigned to the one or more project requirements. The one or more critical project defects may be identified by the defect analyzer 212 based on a predefined weightage assigned to the one or more project defects.

At step 306, the requirement density may be ascertained by the requirement density analyzer 214. The requirement density may be ascertained as a product of the one or more project requirements and the one or more critical project requirements divided by a summation of the one or more project requirements and the one or more critical project requirements.

At step 308, the defect density may be ascertained by the defect density analyzer 216. The defect density may be ascertained as a product of the one or more project defects and the one or more critical project defects divided by a summation of the one or more project defects and the one or more critical project defects.

At step 310, the cumulative risk score may be determined by risk analyzer 206. The cumulative risk score may be determined as a product of the requirement density and the defect density divided by a summation the requirement density and the defect density.

Once the cumulative risk score is determined, the software projects are prioritized based on the cumulative risk score by the risk optimizer 208. One or more levels of risk may be determined by the risk determination engine 102 based on the cumulative risk score. The one or more levels of risk may be low, medium and high. A medium risk level may be determined as average of maximum cumulative risk score and minimum cumulative risk score. A low risk level may be determined as average of minimum cumulative risk score and medium risk level. A high risk level may be determined as average of maximum cumulative risk score and medium risk level.

TABLE B, illustrates an exemplary embodiment for determining risk associated with a software release. In this example, the software release may include a project 1, a project 2, and a project 3. For project 1, the requirement density may be calculated using the equation:

$$Requirement density = \frac{( project requirements \times critical project requirements )}{( project requirements + critical project requirements )}$$

Thus the requirement density for project one may be calculated as:

Requirement density=(23×4.6)/(23+4.6)=4

Similarly, the defect density may be calculated as:

$$Defects density = \frac{( project defects \times critical project defects )}{( project defects + critical project defects )}$$

Thus the defect density for project one may be calculated as:

Requirement density=(11×8)/(11+8)=5

The Cumulative risk score may be calculated as:

$$Cumulative risk score = \frac{( requirement density \times defect density )}{( requirement density + defect density )}$$

Thus the cumulative risk score for project one may be calculated as:

Cumulative risk score=(4×5)/(4+5)=2.

TABLE B

| | | | Requirement | Defect | | | Risk |
|---|---|---|---|---|---|---|---|
| Input Module | | | Analyzer | Analyzer | Density Analyzer | | Analyzer |
| | Total | Total | No. of Critical | No of Critical | Requirement | Defect | Cumulative |
| Projects | Requirement | Defects | Requirement | defects | Density | Density | Risk Score |
| Project 1 | 23 | 11 | 4.6 | 8 | 4 | 5 | 2 |
| Project 2 | 145 | 56 | 29 | 54 | 24 | 27 | 13 |
| Project 3 | 63 | 54 | 12.6 | 42 | 11 | 24 | 7 |

Low, medium and high levels of risk associated with the software project may be determined by the risk determination engine 102 based on the cumulative risk score. A low risk level may indicate successful release of the software project. A medium risk level may indicate a possibility of errors post release of the software project. A high risk level may indicate a possibility of failure post release of the software project. The software projects 1, 2 and 3 are prioritized for optimizing risk based on the cumulative risk score. The software project 1 is prioritized as High Risk. The software project 2 is assigned Medium risk level. The software project 3 is assigned low risk level.

### Computer System

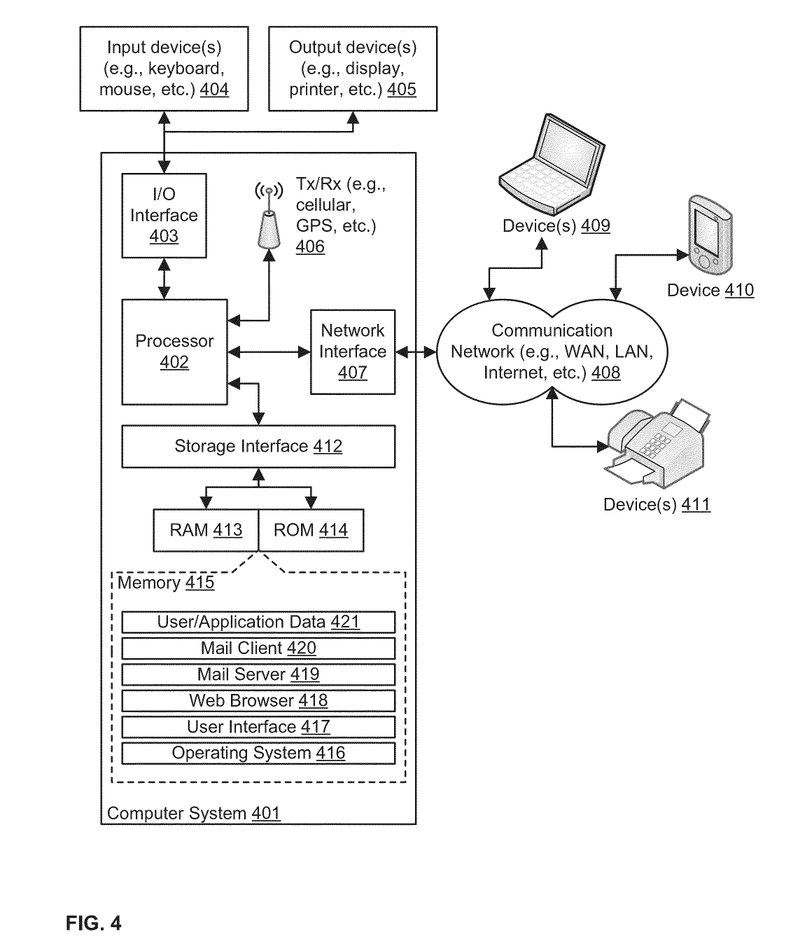

FIG. 4 is a block diagram of an exemplary computer system for implementing embodiments consistent with the present disclosure. Variations of computer system 401 may be used for implementing the risk determination engine. Computer system 401 may comprise a central processing unit (“CPU” or “processor”) 402. Processor 402 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 402 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 402 may be disposed in communication with one or more input/output (I/O) devices via I/O interface 403. The I/O interface 403 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 403, the computer system 401 may communicate with one or more I/O devices. For example, the input device 404 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 405 may be a printer, fax machine, video display (e.g., cathode ray tube (CRT), liquid crystal display (LCD), light-emitting diode (LED), plasma, or the like), audio speaker, etc. In some embodiments, a transceiver 406 may be disposed in connection with the processor 402. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 402 may be disposed in communication with a communication network 408 via a network interface 407. The network interface 407 may communicate with the communication network 408. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 408 may include, without limitation, a direct interconnection, local area network (LAN), wide area network (WAN), wireless network (e.g., using Wireless Application Protocol), the Internet, etc. Using the network interface 407 and the communication network 408, the computer system 401 may communicate with devices 410, 411, and 412. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 401 may itself embody one or more of these devices.

In some embodiments, the processor 402 may be disposed in communication with one or more memory devices (e.g., RAM 413, ROM 414, etc.) via a storage interface 412. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 416, user interface application 417, web browser 418, mail server 419, mail client 420, user/application data 421 (e.g., any data variables or data records discussed in this disclosure), etc. The operating system 416 may facilitate resource management and operation of the computer system 401. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 417 may facilitate display, execution, interaction, manipulation, or operation of program components through textual or graphical facilities. For example, user interfaces may provide computer interaction interface elements on a display system operatively connected to the computer system 401, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 401 may implement a web browser 418 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL) , Transport Layer Security (TLS), etc. Web browsers may utilize facilities such as AJAX, DHTML, Adobe Flash, JavaScript, Java, application programming interfaces (APIs), etc. In some embodiments, the computer system 401 may implement a mail server 419 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 401 may implement a mail client 420 stored program component. The mail client may be a mail viewing application, such as Apple Mail, Microsoft Entourage, Microsoft Outlook, Mozilla Thunderbird, etc.

In some embodiments, computer system 401 may store user/application data 421, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

The specification has described system and method for optimizing the risk during production release. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for determining risk associated with a software project, the method comprising:
receiving, by a risk determination engine, one or more project requirements associated with the software project and one or more project defects associated with the software project;
identifying, by the risk determination engine, one or more critical project requirements and one or more critical project defects from the one or more project requirements and the one or more project defects;
ascertaining, by the risk determination engine, a requirement density for the software project based on the one or more critical project requirements and the one or more project requirements;
ascertaining, by the risk determination engine, a defect density based on the one or more critical project defects and the one or more project defects; and
determining, by the risk determination engine, a cumulative risk score for the software project using the requirement density and the defect density.

2. The method of claim 1, wherein the one or more project requirements and the one or more project defects are received from at least one of a test management tool and a user.

3. The method of claim 1, wherein the one or more critical project requirements are identified based on a predefined weightage assigned to the one or more project requirements.

4. The method of claim 1, wherein the one or more critical project defects are identified based on a predefined weightage assigned to the one or more project defects.

5. The method of claim 1, wherein the requirement density is ascertained as a product of the one or more project requirements and the one or more critical project requirements divided by a summation of the one or more project requirements and the one or more critical project requirements.

6. The method of claim 1, wherein the defect density is ascertained as a product of the one or more project defects and the one or more critical project defects divided by a summation of the one or more project defects and the one or more critical project defects.

7. The method of claim 1, wherein the cumulative risk score is determined as a product of the requirement density and the defect density divided by a summation the requirement density and the defect density.

8. The method of claim 1, wherein the software project is prioritized for optimizing risk based on the cumulative risk score.

9. A risk determination engine to determine risk associated with a software project comprising:
a memory
a processor coupled to the memory storing processor executable instructions which when executed by the processor causes the processor to:
receive one or more project requirements associated with the software project and one or more project defects associated with the software project;
identify one or more critical project requirements and one or more critical project defects from the one or more project requirements and the one or more project defects;
ascertain a requirement density for the software project based on the one or more critical project requirements and the one or more project requirements;
ascertain a defect density based on the one or more critical project defects and the one or more project defects; and
determine a cumulative risk score for the software project using the requirement density and the defect density.

10. The risk determination engine of claim 9, wherein the one or more project requirements and the one or more project defects are received from at least one of a test management tool and a user.

11. The risk determination engine of claim 9, wherein the one or more critical project requirements are identified based on a predefined weightage assigned to the one or more project requirements.

12. The risk determination engine of claim 9, wherein the one or more critical project defects are identified based on a predefined weightage assigned to the one or more project defects.

13. The risk determination engine of claim 9, wherein the requirement density is ascertained as a product of the one or more project requirements and the one or more critical project requirements divided by a summation of the one or more project requirements and the one or more critical project requirements.

14. The risk determination engine of claim 9, wherein the defect density is ascertained as a product of the one or more project defects and the one or more critical project defects divided by a summation of the one or more project defects and the one or more critical project defects.

15. The risk determination engine of claim 9, wherein the cumulative risk score is determined as a product of the requirement density and the defect density divided by a summation the requirement density and the defect density.

16. The risk determination engine of claim 9, wherein the software project is prioritized for optimizing risk based on the cumulative risk score.

17. A computer readable medium including executable instructions to :
receive one or more project requirements associated with the software project and one or more project defects associated with the software project;
identify one or more critical project requirements and one or more critical project defects from the one or more project requirements and the one or more project defects;
ascertain a requirement density for the software project based on the one or more critical project requirements and the one or more project requirements;
ascertain a defect density based on the one or more critical project defects and the one or more project defects; and
determine a cumulative risk score for the software project using the requirement density and the defect density.
